(19) United States
(12) Patent Application Publication
(10) Pub. No.: US 2004/0243422 A1
(43) Pub. Date: Dec. 2, 2004

(54) Event management

(76) Inventors: Goetz M. Weber, Mountain View, CA (US); Dennis B. Moore, Burlingame, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/449,947

(22) Filed: May 30, 2003

(51) Int. Cl. G06F 17/60

(52) U.S. Cl. 705/1

(57) ABSTRACT

Systems and techniques to manage events by messaging an indeterminate and dynamically expanding target population. In general, in one implementation, the technique includes: receiving information corresponding to an event affecting an organization and determining one or more descriptors of a population relevant to the event based on the received event information, the one or more descriptors including at least one descriptor relating to personal scheduling information; identifying a subset of people in the organization relevant to the event based on the one or more descriptors and sending one or more messages, including a request for response, to the identified subset of people; expanding the subset of people based on message response information, sending one or more additional messages, including a request for response, based on the expanded subset of people, and initiating a resolution of the event based on the message response information.

### BACKGROUND

The following description relates to event management, for example, event management in an enterprise management consolidation system.

Various systems are available for managing different aspects of a business enterprise. Some of these systems include event management techniques that involve messaging or otherwise notifying a defined population in response to an event. For example, in a traditional business management tool, alerts typically are sent to a defined user population when a management event occurs in the management tool. The user population that is notified is typically defined by user associations previously stored with a project to which the event pertains or stored in organizational hierarchies. Thus, users that have a defined relationship with a business management tool can be notified when events occur that can have impact on the project being managed with the tool. When an event occurs that does not fit within the planning framework of a traditional business management tool or needs immediate attention (e.g., a customer calls with a software problem that needs immediate attention by the best available person), frequently such an event is handled by people using interpersonal contacts and skills to track down an appropriate person to address the event, which can take many phone calls and many man-hours.

### SUMMARY

The present application describes systems and techniques relating to management of events with an expandable target population to message. Internal or external events that impinge on an organization can be responded to, or otherwise handled, by automatically identifying and messaging a dynamic group of individuals within the organization, the target population. The parameters that govern the target population to message for a given event can be dynamic, and depend on the population itself and/or the nature of the event. The system can be termed a critical event management (CEM) system and can be implemented as an application that pulls the information used in managing events from multiple base systems. For example, the personnel data used to identify the target population can be pulled from existing human resources systems, project systems and a mail-calendaring system.

A CEM system can manage, categorize and track events independently from systems that originate the events. A CEM system can identify and message the most relevant population for an event, provide this population with sufficient information and collaborative power to address the event, and also manage exception handling, such as non-availability. Given an event with an indeterminate population, a best guess at the target population can be determined, and the target-population problem space can be iterated over until the indeterminate population is approximated sufficient to enable resolution of the event. By aligning the data on people (e.g., skills, schedule, and location) with the data about the community in which they operate (e.g., people on the same project, people having the same calendar item), the relevant user population can be accurately identified and messaged, based on the nature of the event. The systems and techniques described can reduce the time-to-resolution of a customer problem and can enable a quick response to an emergency event. Moreover, the systems and techniques provide substantial economies of scale as an organization grows, reducing the number of man-hours needed to respond to critical events.

In one aspect, information corresponding to an event affecting an organization can be received, and one or more descriptors of a population relevant to the event can be determined based on the received event information. The one or more descriptors include at least one descriptor relating to personal scheduling information. A subset of people in the organization relevant to the event can be identified based on the one or more descriptors. One or more messages, including a request for response, can be sent to the identified subset of people. The subset of people can be expanded based on message response information, and one or more additional messages, including a request for response, can be sent based on the expanded subset of people. A resolution of the event can be initiated based on the message response information. The message response information can include non-response information, and the subset of people to message can be expanded due to a lack of response from initially message people (e.g., when no responses are forthcoming, the system can reach out to a population that may not have been chosen on the basis of skills and location alone).

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a flowchart illustrating event management.

FIG. 2 is a flowchart illustrating exemplary details of event management.

FIG. 3 illustrates parameters that can be used to produce a target population to message.

FIG. 4 is a block diagram illustrating exemplary information sources and functionality in an event management system.

FIG. 5 is a block diagram illustrating exemplary event management.

FIG. 6 is a block diagram illustrating an example event management system.

FIG. 7 is a block diagram illustrating an example integrated enterprise management system.

FIG. 8 is a block diagram illustrating components of an example enterprise management consolidation system.

Like reference symbols in the various drawings indicate like elements.

### DETAILED DESCRIPTION

The systems and techniques described here relate to event management, where the events have an indeterminate target population to message. Such events are frequently referred to here as critical events to indicate that a quick resolution is desired, but the events to be managed are not necessarily critical, in the sense of being vital or essential, to the operation or success of a business enterprise or other entity. A critical event is any event having an indeterminate target population to notify, either because the best people to respond to the event are unknown (e.g., not in the system as associated with the task/project that an event relates to), or because the best people to respond to the event currently are unavailable and a backup contact is needed.

Given an event, an associated target population can be identified, and while someone in that population is unavailable (e.g., hasn't responded yet or is in a significantly different time zone), the target population can be iterated over to expand the population to message. For example, if the designated expert for a given issue is currently on vacation, the next best contact for that issue can be found by looking at affiliation information, such as by checking who has worked with the expert previously and who has shared calendar items with the expert on a subject relevant to the event. Using data mining and text retrieval and extraction techniques, information regarding the personal networks that make up an organization can be derived from existing information system repositories, such as skills databases, calendar items, and emails that describe interactions among the people in the organization. For example, TREX, which is provided by SAP of Walldorf, Germany, can be used to search and examine information repositories in multiple systems and derive the personal networks information used in expanding the target population.

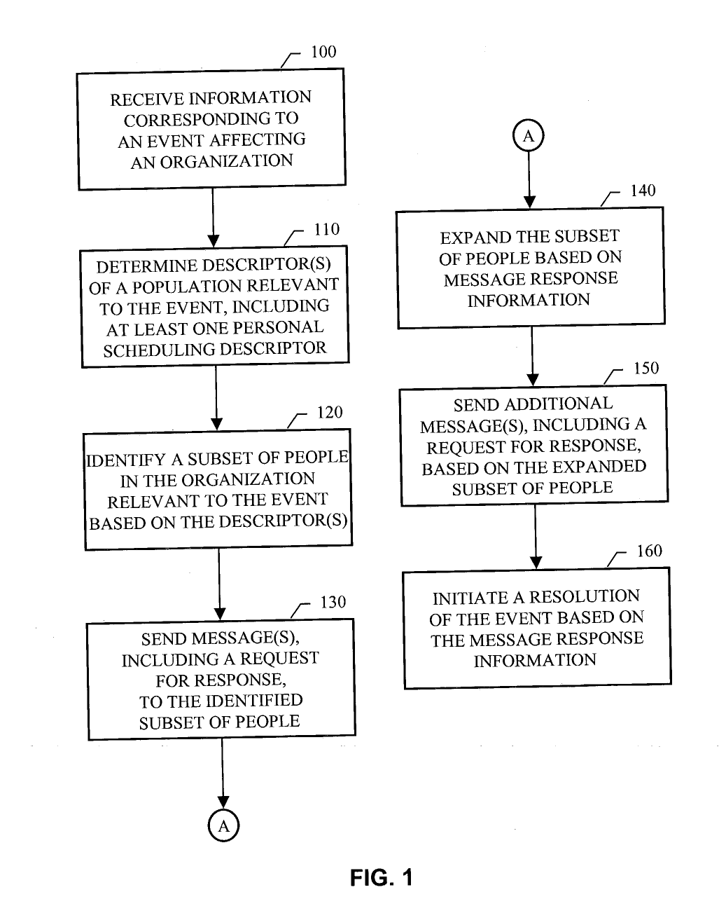

FIG. 1 is a flowchart illustrating event management. Information corresponding to an event affecting an organization can be received at 100. The event can be internal or external to an organization and can be initiated by a person (e.g., entered on a screen) and/or by a process/system. Events that can be triggered by external systems include occurrences such as a change in credit rating of a customer, the non-delivery of certain goods, or the bouncing of a check. Events that can be triggered by internal systems of an enterprise include occurrences such as the creation of an alert in a payment or goods-receipt system or alerts as raised by a Business Alert Management (BAM) system, a Business Intelligence (BI) system, and/or a project management system.

An event can emanate from a project in a project management system, but an event need not have a defined structure like a project. Events can be function-specific in the sense of the line function as held in an organization (e.g., finance, logistics, sales, support, etc.) such that an initial target population can be generated based on the nature of the event and the associated function. For example, the failure of a supply chain, such as due to loss of a shipment or break-down of a supply vehicle, can be an event that results in an initial target population including all employees known to be managers of that supply chain. Additionally, the target population for an event can be dynamically expanded based on many factors, which need not relate to any business function. For example, an event can be a failure of a customer's software system and the target population can be anyone in the company who is able to fix the customer's problem (e.g., alert anybody who can fix this, alert anybody in the neighborhood with a skill set range, alert everybody in this city, alert somebody who is working with a targeted person (i.e., someone in the same location as a targeted person who is not responding)).

Many other types of events can be handled. The event can be the bankruptcy declaration of a customer, which can result in a message being sent to everyone in the enterprise potentially in contact with that customer, where the message indicates no more sales, support, service or bug-fixes are to be provided to the customer. The event can be a traffic jam, a plane crash, a factory or office shut down, a loss of electricity, etc. An event can be any occurrence that impacts an organization and that should be resolved quickly by the best available person. Moreover, an event can be triggered by an event identification process that scans network resources to proactively identify events (e.g., software that scans news stories to identify plane crashes, extreme weather, etc.).

One or more descriptors of a population relevant to the event can be determined based on the received event information at 110. The descriptor(s) can include at least one descriptor relating to personal scheduling information (e.g., the descriptor can require the people included in the target population to be currently available and/or have been at a certain place at a certain time). The personal scheduling descriptor relates to availability of a person, either current availability or past schedules, and the target population for the event can be defined as those people in an organization who match the personal scheduling descriptor. The descriptor(s) can also relate to other personal information that can affect a person's ability to handle a particular event, such as skills, affiliation, and location information. Determining the descriptor(s) can involve retrieving the descriptor(s), or deriving the descriptor(s), from the received event information.

A subset of people in the organization relevant to the event can be identified based on the one or more descriptors at 120. Identifying this subset of people can involve checking skills information, affiliation information, location information, and schedule information against the descriptor(s). This information can be obtained from personnel information pulled from multiple base systems and/or derived from information associated with personnel (e.g., data mining of email traffic and calendar entries). The subset of people can be a dynamic group of individuals that is aligned with the event and managed throughout the event-lifecycle process, while being provided with the relevant tools and information around the specifics of the event.

One or more messages, including a request for response, can be sent to the identified subset of people at 130. The messages can include information and other forms of provisioning (e.g., systems' access) used to initiate a resolution of the event. The request for response in the messages can be used to manage the event lifecycle by changing the target population based on received responses and/or a lack thereof. The messages can be email messages, instant messages, pager messages, or virtually any other type of electronic notification over a wired or wireless medium. The messages can include event message information retrieved from the received event information, where the event message information specifies the types of responses sought.

The subset of people can be expanded based on message response information at 140. The message response information can be a lack of response, or information received in a response from someone in the target population. For example, the event can have a measure of criticality (e.g., urgency, importance or a combination of both) associated with it, and if no useful response is received before passage of a period governed by the measure of criticality, the subset of people can be expanded. Expanding the subset of people can involve checking skills information, affiliation information, location information, and schedule information, including using data mining and text retrieval and extraction techniques to discover tacit knowledge of individuals in the organization. Moreover, expanding the subset can be an ongoing process, and/or the message response information can trigger the expansion, such as when a response includes a name of someone to contact to address the event, or when a response is an automatically generated response indicating the messaged person is unavailable (e.g., an automatic out-of-office reply can be received and processed to determine that the target population should be expanded).

One or more additional messages, including a request for response, can be sent based on the expanded subset of people at 150. A resolution of the event can be initiated based on the message response information at 160. Initiating the resolution can involve accepting a responder to handle the event. Initiating the resolution can involve generating a suggested resolution and sending the suggested resolution to a person associated with the received event information.

Initiating the resolution can also be based on a measure of criticality of the event determined based on the received event information. For example, an event that is very important can result in a first responder, who has at least some ability to handle the event, being assigned to do so. And the event can continue to be managed during the resolution process, allowing the possibility of a more skilled individual being contacted later and added to, or replacing, the one or more people currently addressing the event. Thus, the most relevant population for an event can be dynamically identified and messaged, including during the course of addressing the event itself. This dynamic population can be readily provided with information, links and/or functionality to handle the event, enabling a rapid time-to-resolution for critical events in an organization.

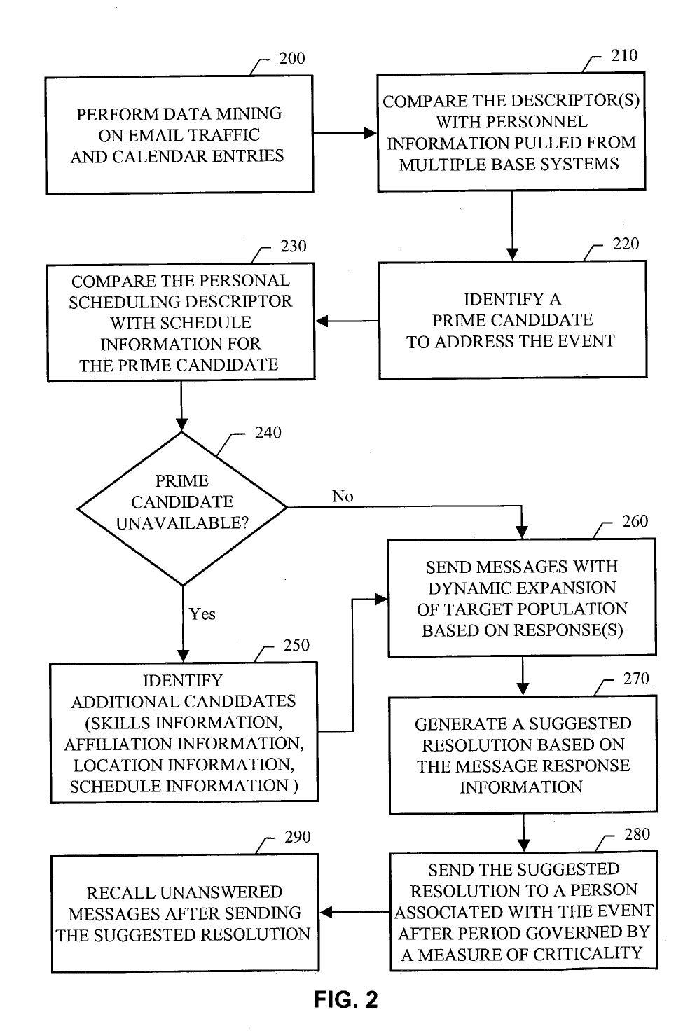

FIG. 2 is a flowchart illustrating exemplary details of event management. Identifying the dynamic population to message in response to received event information can involve multiple processes and multiple iterations. Information concerning people that may be added to the target population to message can be obtained from many sources. Data mining can be performed at 200 on email traffic and calendar entries. The one or more descriptors can be compared at 210 with personnel information pulled from multiple base systems. The multiple base systems can be a human resource management system, a project management system, a time management system, and a communications management system. Moreover, operations to identify people as belonging to the target population can be performed in parallel, such as by using the personnel information to identify an initial group to message, messaging that group, and using data mining techniques to identify additional people to message in a second round of messaging while waiting for the initial group to respond to the event based on the first round of messages.

A prime candidate to address the event can be identified at 220. This prime candidate might be a preferred responder to the event based on existing systems' management information (e.g., the event relates to a project, and the prime candidate is the manager of that project). A descriptor relating to personal scheduling information can be compared at 230 with schedule information for the prime candidate. If the prime candidate is currently unavailable at 240, then additional candidates can be identified at 250. As before, this can involve looking at skills information, affiliation information, location information, and schedule information. For example, if a calendar entry for the prime candidate shows that the prime candidate is currently on an airplane, additional candidates can be identified by looking for people who are affiliated with the prime candidate (e.g., same office location or work on the same project) and who meet any other criteria for handling the event (e.g., a certain skills base). Thus, identifying the target population can be a dynamic and iterative process.

Messages can be sent at 260 with dynamic expansion of the target population such as described above. The target population can be expanded based on one or more responses, or lack of response, to previous messages. New message can be sent based on the expanded target population. Moreover, initiating a resolution of an event can also be a dynamic and iterative process.

A suggested resolution can be generated at 270 based on the message response information. The suggested resolution can be generated based on one or more received responses and/or a lack of response to the sent messages. The suggested resolution can be sent at 280 to a person associated with the received event information. The suggestion can be sent after a period governed by a measure of criticality for the event. When the event has been fully resolved, or when the event no longer needs to be managed by the system, unanswered messages can be recalled at 290. For example, after sending the suggested resolution, the system can automatically recall sent emails that were sent for the event but that have not yet been read, thus, potentially reducing time lost reading stale messages.

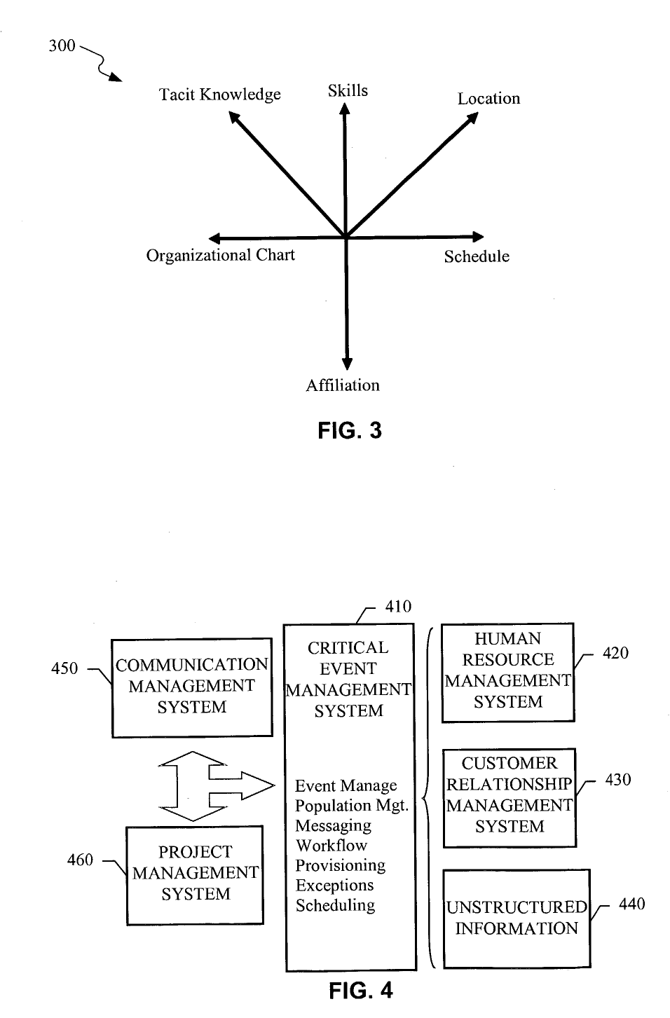

FIG. 3 illustrates parameters that can be used to produce a target population to message. In general, relevant information for identifying the proper target population can be located in the nature of the event, personnel scheduling information, project information (e.g., a project management repository), documents (e.g., emails and calendar items), and human resource (HR) information (e.g., skills, organizational data, extended master data). FIG. 3 shows a visual representation 300 of the parameters that can be used when identifying the target population to message. Finding information aligned with these parameters can be done using multiple base systems and data mining techniques.

Affiliation information (e.g., ‘team-member’ or ‘have-worked-on’ information) provides links between people that may indicate additional people that can handle an event. The affiliation information can include common membership in relevant organizational groups (e.g., common membership on a project team), and deduced affiliations such as that obtained by observing a shared calendar item with a subject related to the event. Organizational chart information provides organization hierarchy information for use in identifying people relevant to an event. Tacit knowledge provides information that summarizes experience and qualifications (e.g., terms indicating one or more subjects of personal knowledge) that need not be located in a skills record for an individual, or even in a skills taxonomy of an enterprise management system.

Skills information can come from an existing enterprise management system and provides information that summarizes skills held by individuals in an organization, which may be useful in responding to a critical event. Location information corresponds to current or past physical locations of individuals, and schedule information corresponds to current or past availability and timing of activities (e.g., calendar entries and travel data). Schedule, location, skills and affiliation information can all be derived using data mining techniques (e.g., a person's current location can be obtained by searching calendar entries).

FIG. 4 is a block diagram illustrating exemplary information sources and functionality for an event management system 410. The critical event management (CEM) system 410 can access data in a human resource management system 420 (e.g., master HR data and additional personnel data), a customer relationship management (CRM) system 430 (e.g., service items and customer data), or in unstructured information 440 (e.g., documents and external data). The CEM system 410 can also interact with a communication management system 450 that includes both calendar and email functions. For example, the communication management system 450 can be MS Outlook, provided by Microsoft Corporation of Redmond, Wash., and the CEM system 410 can examine Outlook meeting attendee lists. The CEM system 410 can also interact with a project management system 460 with task management functions, such as MS Project, provided by Microsoft Corporation of Redmond, Wash.

The CEM system 410 can provide event management, target population management, messaging, workflow, provisioning, exception handling and scheduling. The CEM system 410 unifies a population with an event. From a system's perspective, the event can be managed by the CEM system while the data on personnel reside in other systems 420, 430, 440, 450, 460. According to an implementation, the CEM system 410 can be used to (1) input and categorize events from external and internal sources, (2) structure the event and create an event body using event templates and content, (3) broadcast the event to a target population that is a function of the event category and event parameters, such as location, while taking into account a workflow that respects existing organizational decision-making structures, (4) execute a response workflow that iterates over the event and target population, taking into account that the target population may not respond, and hence modifications to the target group may have to be made (and iterated over), and (5) analyze events and their responses with respect to time and other parameters to enable a prediction for subsequent similar events.

Thus, the population to be messaged can be dynamic and can be based on the event category and responses from the initially targeted population. Instead of describing a population using a traditional static distribution list, the target population can be described by a combination of event, schedule, location, skills and affiliation information. The target population can be a dynamic, event-based population (i.e., the event population) that is not fully determinable upon the generation of the event because the target population depends at least in part on the response of the initially messaged population, giving rise to an event-based, dynamically generated distribution list.

In addition, once an event has triggered a round of messages to a user population, a feedback cycle can be initiated using a response workflow system (RWS). Processing of the event and the event population by the RWS can result in an expansion of the event population. For example, it may be learned that the primary contact for an event is on sabbatical, and a secondary contact may be found based on an affiliation with the primary contact (e.g., the secondary contact is not in the initial event population but is added to the event population because he shares an office with the primary contact). Various metrics of event management, such as who actually responded, and how quickly the event was resolved can be tracked to facilitate learning from past management of critical events.

Such metrics can be analyzed using an event analysis and predictive methods system. Thus, the predictive capability of the event management system can increase over time as more events are registered. The analysis can take into many factors, such as time-to-resolution of an event, length of a communication chain (e.g. how many people were messaged after the primary person was found to be on sabbatical?), etc. The results of such analyses can be tied back into identification a prime candidate, and the system can learn about variables that may not be defined during an initial population identification process. Thus, the system can identify new variables to use in identifying a prime candidate in the future base on prior event transactions.

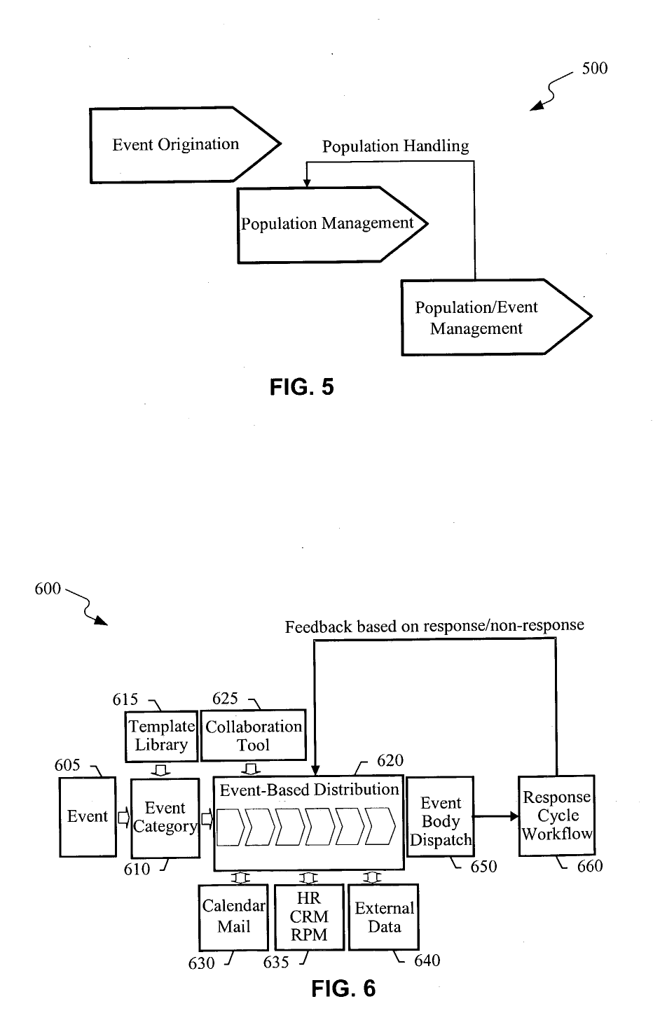

FIG. 5 is a block diagram illustrating exemplary event management 500. Event management can be understood as three main activities: event origination, population management, and population/event management. Event origination can involve event registration, event classification, content preparation, and identification of a desired action. Population management can involve determination of a population to message and provisioning (providing the information and/or access/functionality needed to initiate a resolution of the event). Population/event management can involve messaging, workflow, event management, and analysis processes.

The CEM system can manage the entire lifecycle of a critical event. During event registration and classification, the event can be enriched with supporting information and infrastructure. An event body that contains the pertinent information (e.g., suggested actions and provisions) relevant to the event population can be created. Determination of the relevant population for event handling can be based on a set of dynamic parameters, which can be determined by the event category and situational factors. For example, an event-based dynamically generated distribution list for messaging can be created using event-category configured templates. An event classification template can be used to describe the real-world event and produce an event in the system to be managed. A response workflow cycle can manage the post-contact event and population handling, including potentially expanding the event population to message (e.g., because a subset of the population is unavailable, which can be derived knowledge or expressly included in a response).

Various event analysis and predictive methods can be used to improve event management over time, such as by analyzing the response history for events to improve predictive capabilities. The event analysis and predictive capabilities can allow a plethora of reports and statistics to be generated. In addition, the system can analyze the event management history to make predictions based on a repository of events.

FIG. 6 is a block diagram illustrating an example event management system 600. An event registration and categorization component 610 can process events 605, which may be initiated by a user (e.g., entered in an event registration form) or triggered by external or internal systems. Events can be processed and aligned with a category. The event category corresponds to the nature of the event and provides a framework for the event handling mechanism. Depending on the nature of the event, content may be pre-configured into an event body. The event categorization can be open and flexible, and can enable specification of one or more aspects of the event that correspond to the descriptor(s) of the target population, including time frame, location and knowledge base. Event categories can be configurable and the system can respond to events that can be parsed to an existing event category. Event categories can be defined in a template library 615, and events can be linked to several event categories. A set of standard events, such as customer emergency and personnel emergency, can be provided. A new event can be categorized into the set of standard events, and appropriate actions for the event can then follow. The categorization of events can include preset information to be broadcast and/or systems access information/functionality.

The event population to message corresponds to the user population relevant for a given event (e.g., all service technicians associated with customer X). An event-based distribution component 620 can read an event category and additional parameters to create the event-based dynamically generated distribution list. This information can be used to name individuals that align with descriptors for the event. Example descriptors can correspond to various parameters, including skills, location, schedule, and affiliations. Sources of personnel information can include a collaboration tool 625 (e.g., the Team Room portal collaboration application provided by SAP of Walldorf, Germany), a calendar-mail system 630, and one or more business management tools 635 (e.g., an HR tool, a CRM tool, and a project management tool, such as the Resource and Program Management (RPM) software provided by SAP of Walldorf, Germany). Various external data sources 640 can also be used.

Based on the event information and the personnel information, the event-based distribution component 620 can provide a list of names and/or pointers and additional information, and synchronizes this with a workflow that determines the authority process of contacting people within the selected population (e.g., messaging of the target population can be done in stages). An event body dispatch component 650 can invoke and send the messages to the target population, such as by using email, voicemail, pager, etc. The message can describe the actions to be taken in response to the event. The classification of such actions can be derived from the event category (e.g., the action “evacuate” in case of the event “fire”) or transferred from the body of the message.

A response cycle workflow component 660 can handle responses (or lack thereof) and trigger a reworking of the event population and associated workflow to expand the target population (e.g. taking absentees into account), and subsequent messages can be invoked, while keeping an audit trail of who has responded, declined, etc. As used here, the phrase “expand the target population” means adding people that were not previously included, regardless of whether other people are removed from the population. By iteratively expanding the target population, an ever-increasing population can be notified of the event to rapidly resolve the event, even when the initial target population fails to address the event. The audit trail can be used to track data for reporting purposes.

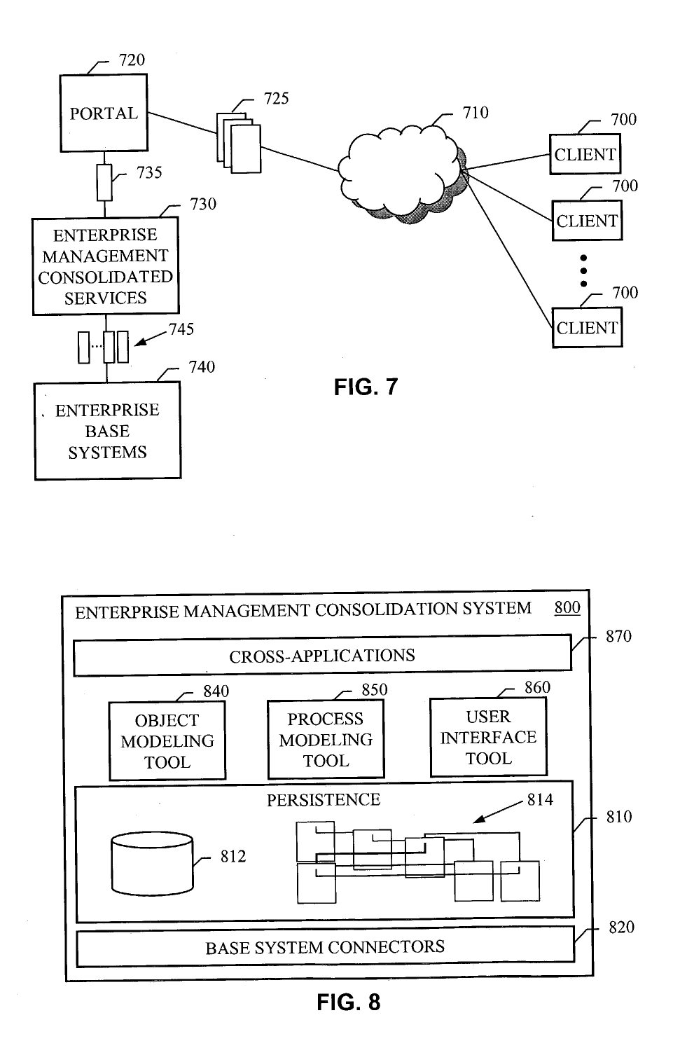

FIG. 7 is a block diagram illustrating an example integrated enterprise management system. Multiple clients 700 can access data over a network 710 through a portal 720. The network 710 can be any communication network linking machines capable of communicating using one or more networking protocols, e.g., a local area network (LAN), a wide area network (WAN), an enterprise network, a virtual private network (VPN), and/or the Internet. The clients 700 can be any machines or processes capable of communicating over the network 710. The clients 700 can be document browser applications (e.g., a Web browser) and can be communicatively coupled with the network 710 through a proxy server.

The portal 720 provides a common interface to various services. The portal 720 receives requests from the clients 700 and generates information views 725 (e.g., Web pages) in response. The portal 720 can implement a user roles based system to personalize the common interface and the information views 725 for a user of a client 700. A user can have one or more associated roles that allow personalized tailoring of a presented interface through the generated information views 725.

The portal 720 communicates with an enterprise management system 730 that consolidates multiple application services. The portal 720 receives data 735 from the enterprise management system 730 for use in fulfilling the requests from the clients 700. The enterprise management system 730 can provide integrated application services to manage business objects and processes in a business enterprise. The business objects and processes can be resources (e.g., human resources), development projects, business programs, inventories, clients, accounts, business products, and/or business services.

The enterprise management system 730 communicates with enterprise base systems 740 to obtain multiple types of data 745. The enterprise base systems 740 can include various existing applications and systems, such as human resource management systems, customer relationship management systems, financial management systems, project management systems, knowledge management systems, business warehouse systems, time management systems, and electronic file and/or mail systems. The enterprise base systems 740 also can include an integration tool, such as the eXchange Infrastructure (XI) provided by SAP of Walldorf, Germany. The enterprise management system 730 can consolidate and integrate the data and functionality of such systems, in a heterogeneous information technology (IT) environment, into a single enterprise management tool.

This enterprise management tool can include systems and techniques to facilitate creation of new applications within the enterprise management system 730. These new applications can readily draw on the resources of the enterprise base systems 740 to cross over traditional enterprise application boundaries and handle new business scenarios in a flexible and dynamic manner, allowing rapid and continuous innovation in business process management. A virtuous business cycle can be created using such cross-applications, where executive-level business strategy can feed management-level operational planning, which can feed employee-level execution, which can feed management-level evaluation, which can feed executive-level enterprise strategy. The information generated at each of these stages in the enterprise management cycle can be readily consolidated and presented by the enterprise management system 730 using customized cross-applications. The stages can provide and consume determined services that can be integrated across multiple disparate platforms.

The portal 720, enterprise management system 730 and enterprise base systems 740 can reside in one or more programmable machines, which can communicate over a network or one or more communication busses. For example, the base systems 740 can reside in multiple servers connected to an enterprise network, and the portal 720 and the enterprise management system 730 can reside in a server connected to a public network. Thus, the system can include customized, Web-based cross-applications, and a user of the system can access and manage enterprise programs and resources using these customized Web-based cross-applications through a single portal from anywhere that access to a public network is available.

FIG. 8 is a block diagram illustrating components of an example enterprise management consolidation system 800. The system 800 can include a persistence layer 810 and one or more base system connectors 820. The base system connectors 820 enable data exchange and integration with base systems. The base system connectors 820 can include a BC (Business Connector) interface, an ICM/ICF (Internet Communication Manager/Internet Communication Framework) interface, an Encapsulated PostScript® (EPS) interface, or other interfaces that provide Remote Function Call (RFC) capability.

The persistence layer 810 provides the enterprise management consolidation system 800 with its own database 812 and data object model 814. The database 812 and the object model 814 provide a consolidated knowledge base to support multiple enterprise management functions, including functions created as cross-applications 870. One such function can be event management as described above. Active communication between the persistence layer 810 and the base systems can provide a tight linkage between real-time operational data from multiple base systems and an integrated enterprise management tool to allow strategic enterprise management and planning. One of the cross-applications 870 can be a CEM application, making the system 800 into a CEM system as well.

The data object model 814 can represent a subset of data objects managed by the base systems. Not all of the data aspects tracked in the base systems need to be recorded in the data object model 814. The data object model 814 may have defined relationships with data objects stored in the base systems, for example, certain objects in the data object model 814 may have read only or read-write relationships with corresponding data objects in the base systems. These types of defined relationships can be enforced through the communication system built between the persistence layer 810 and the base systems. Thus, the persistence layer 810 can be used to effectively decouple application development from the underlying base systems.

The cross-applications 870 can take advantage of this decoupling from backend systems and can be created using a set of tools that enable efficient development of cross-applications 870, which can drive business processes across different platforms, technologies, and organizations. The cross-applications 870 can support semi-structured processes, aggregate and contextualize information, tackle event-driven and knowledge-based scenarios, and support a high degree of collaboration in teams, including driving collaboration and transactions. The set of tools enable efficient development of the cross-applications 870 by providing application patterns that support model-driven composition of applications in a service-oriented architecture.

An object-modeling tool 840 enables creation of new business objects in the persistence layer 810 by providing a mechanism to extend the data object model 814 dynamically according to the needs of an enterprise. A process-modeling tool 850 enables creation of new business workflow and ad hoc collaborative workflow. A user interface (UI) tool 860 provides UI patterns that can be used to link new objects and workflow together and generate standardized views into results generated by the cross-applications 870. The object modeling tool 840, the process modeling tool 850 and the UI tool 860 can thus be used to build the components of cross-applications 870 to implement new enterprise management functions without requiring detailed coding activity.

The process-modeling tool 850 can include guided procedure templates with pre-configured work procedures that reflect best practices of achieving a work objective that is part of a larger cross-application scenario. Such a work procedure can include contributions from several people, creation of multiple deliverables, and milestones/phases. The guided procedure templates can be provided in both industry-specific and generic versions. Moreover, whenever an instantiated business object or work procedure has lifetime and status, the progress and status of the object or work procedure can be made trackable by the process owner or involved contributors using a dashboard that displays highly aggregated data. Objects, such as work objects, can be extensible; a user can add new attributes or deleting optional attributes, and can set rules. The dashboard and a myOngoingWork place can be two UI patterns that are provided by the UI tool 860.

An Object Picker UI pattern can be included that lets users pick their favorite object directly. The Object Picker UI pattern can be provided by the UI tool 860, and UI objects can include myObjects, myRecentObjects, myRelatedObjects or myPreferredObjects. When searches for people are to be conducted, either for choosing one individual person or for generating a collection of people meeting some criterion, a People Finder component can be applied. A key aspect of searching for a person can be described as an attribute within the user's activity, qualification, interest, and collaboration profile. For a given cross-application scenario, people collections can be stored as personal or shared collections using the People Finder to make them available for further operations later on.

Whenever there is a strategic view on a cross-application scenario, there can be a place described in which analytics of the overall portfolio are made available in the form of a collection of UI components. A view selector can be used to display/hide components, and a component can be toggled between graphical and numerical display and can include a drop-down to select sub-categories or different views. Portfolio views for projects and processes can include comparisons to other projects and processes, optionally including external benchmarks.

Portfolio views for projects and processes can also include comparisons of actual to plan/budget (including differing versions of plan/budget). Portfolio views can be user-modifiable: sorting axes/columns, applying filters based on criteria like where clauses with wildcards, applying filters for inclusion or exclusion of specific items, display properties (appearance), displayed attributes/columns, and aggregation. Modified portfolio views can be named, saved, and shared with others. Portfolio views can be printed, e-mailed, copied to the clipboard, exported to other applications, etc.

Cross-application scenarios can provide related information to the user when possible, and some parts within a larger cross-application scenario can define what kind of related information is to be offered. Heuristics can be used to identify such relatedness, such as follows: (1) Information that is related to the user due to explicit collaborative relationships such as team/project membership or community membership. (2) Information that is similar to a given business object in a semantic space based on text retrieval and extraction techniques, including information that is extracted internal sources (e.g., intranet documents like company emails) or external sources (e.g., news feeds, Web documents, etc.). (3) Recent objects/procedures of a user. (4) Other people doing or having done the same or similar activity (e.g., using same object or procedure template, having same workset). (5) Instances of the same object class, such as “successful” or “best practice” instances. (6) Instances of objects directly related to this object instance in the object model (e.g., when viewing/editing a customer, show related information for that customer, such as contact people, meetings, orders, open service requests, or assigned employees. (7) Explicit relationships on the organizational or project structure. (8) Proximity on the time scale (i.e., “temporal breadcrumbs” or “actions I have done recently”). (9) Information about the underlying business context. (10) Information about the people involved in a collaborative process. (11) Recent object instance versions (i.e., edits or change history). (12) Recent searches performed against this object type by this user. (13) Context-sensitive help for the object, attribute, or instance currently in focus.

Cross-applications also can include generic functionality in the form of ControlCenter Pages that represent generic personal resources for each user. These cross-applications can refer to the following pages where appropriate: (1) MyStatus page: provides an automatically-generated status report, including prioritized open issues and notifications.

(2) MyOngoingWork page: provides instant access to all dashboards that let users track their ongoing work. Ongoing work may refer to the state of business objects as well as guided procedures. (3) MyDay page: lists today's time based events that are assigned or related to the user. (4) MyMessageCenter page: Displays all pushed messages and work trigger using a universal inbox paradigm with user selected categorical filters. (5) MyInfo: Provides access to all personal info collections (documents, business objects, contacts) including those located in shared folders of teams and communities that the user is member of. Provides targeted search in collaborative info spaces such as team rooms, department home pages, project resource pages, community sites, personal guru pages. ControlCenter pages can be made accessible through text-to-speech interfaces (e.g., via phone), and various available actions (e.g., approvals for inbox items) can be made accessible through speech-to-text interfaces.

The systems and techniques described above can be implemented in many different event management contexts. For example, in one implementation, the enterprise management consolidation system 800 includes a CEM system that operates in conjunction with a corporate suggestion box. A person with a suggestion about an improvement or issue that needs to be resolved may not know the one or more individuals in the company who are best able to assist or otherwise address the issue. A CEM system in an integrated IT environment can receive a submitted suggestion and translate it into an event (e.g., parse the input to identify an event in the category of “suggestion”). A data-mining operation can parse the body of the suggestion and extract key terms. These key terms, together with the event category, can initiate a search for a suitable candidate for follow-up actions. Once this candidate is located, a message and actionable item can be created and forwarded to the individual, perhaps with a caveat to respond within a certain timeframe (e.g., based on event criticality). The actions can be logged for auditing purposes.

Other management contexts in which a CEM system can be implemented include customer relationship management and critical systems management. For large companies, managing customer relationships can be a time-consuming process, and a CEM system can be used to quickly identify the best person to respond to a customer problem (e.g., if the customer is in Sri Lanka, the CEM system can identify that an employee in Sri Lanka with less expertise than another employee in Germany might be the best person to respond). Critical systems management includes management of critical machines (e.g., a magnetic resonance imaging device in a hospital) and management of critical computer systems (e.g., banking, defense and medical computer systems).

Moreover, the systems and techniques described can also be used to manage events that require identification of a population that is currently unavailable (e.g., because they are stuck in traffic or were in a plane crash). For example, in the event of plane crash, a company may need to quickly identify all employees who were on the plane. This can be done using the identification and messaging techniques described, where the target population can include both people suspected of being on the plane (i.e., a lack of response to a message for such person is treated as evidence of that person having been on the plane) and people that may have information concerning who was on the plane.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., a data server), a middleware component (e.g., an application server), and a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network).

Although only a few embodiments have been described in detail above, other modifications are possible. The logic flows depicted in FIGS. 1 and 2 do not require the particular order shown, or sequential order, to achieve desirable results. In certain implementations, multitasking and parallel processing may be preferable.

Other embodiments may be within the scope of the following claims.

What is claimed is:

1. A method comprising:
receiving information corresponding to an event affecting an organization;
determining one or more descriptors of a population relevant to the event based on the received event information, the one or more descriptors including at least one descriptor relating to personal scheduling information;
identifying a subset of people in the organization relevant to the event based on the one or more descriptors;
sending one or more messages, including a request for response, to the identified subset of people;
expanding the subset of people based on message response information;
sending one or more additional messages, including a request for response, based on the expanded subset of people; and
initiating a resolution of the event based on the message response information.

2. The method of claim 1, wherein identifying the subset of people comprises identifying people that match the one or more descriptors to a first degree, and expanding the subset of people comprises identifying people that match the one or more descriptors to a second degree if the message response information comprises a lack of response.

3. The method of claim 1, wherein identifying the subset of people comprises performing data mining on email traffic and calendar entries.

4. The method of claim 1, wherein identifying the subset of people comprises comparing the one or more descriptors with personnel information pulled from multiple base systems.

5. The method of claim 1, wherein identifying the subset of people comprises:
identifying a prime candidate to address the event;
comparing the at least one descriptor relating to personal scheduling information with schedule information for the prime candidate; and
identifying additional candidates if the prime candidate is currently unavailable.

6. The method of claim 5, wherein identifying the additional candidates comprises checking skills information, affiliation information, location information, and schedule information.

7. The method of claim 1, wherein initiating the resolution of the event is further based on a measure of criticality of the event determined based on the received event information.

8. The method of claim 7, wherein initiating the resolution comprises:
generating a suggested resolution based on the message response information; and
sending the suggested resolution to a person associated with the received event information after a period governed by the measure of criticality.

9. The method of claim 8, wherein expanding the subset of people is performed after another period governed by the measure of criticality.

10. The method of claim 8, wherein generating the suggested resolution comprises generating the suggested resolution based on a lack of response.

11. The method of claim 8, wherein initiating the resolution further comprises recalling unanswered messages after sending the suggested resolution.

12. The method of claim 1, wherein receiving the information corresponding to the event comprises receiving event-specific information generated using an event classification template.

13. The method of claim 12, wherein the at least one descriptor relating to personal scheduling information comprises an implicit descriptor requiring current availability, the implicit descriptor being implicit in an event class for the event.

14. The method of claim 12, wherein determining the one or more descriptors comprises retrieving the one or more descriptors from the received event-specific information.

15. The method of claim 12, wherein sending the one or more messages comprises sending an email message including the request for response and event message information retrieved from the received event-specific information.

16. A system comprising:
an event registration and categorization component that aligns an event with a category that corresponds to a nature of the event;
an event-based distribution component that creates an event-based dynamically generated distribution list corresponding to the event and the category and that causes messages to be sent based on the event-based dynamically generated distribution list; and
a response cycle workflow component that handles message response information and causes the event-based distribution component to expand the event-based dynamically generated distribution list and invoke new messages based on the message response information.

17. The system of claim 16, wherein the event-based distribution component comprises a data mining component used in creating the event-based dynamically generated distribution list.

18. The system of claim 16, wherein the event-based distribution component pulls personnel information from multiple base systems to use in creating the event-based dynamically generated distribution list.

19. The system of claim 18, wherein the multiple base systems comprise a human resource management system, a project management system, a time management system, and a communications management system.

20. The system of claim 18, wherein the personnel information comprises skills information, affiliation information, location information, and schedule information.

21. A system comprising:
means for identifying a target population to respond to an event affecting an organization based on one or more descriptors of people relevant to the event, the one or more descriptors including at least one descriptor relating to personal scheduling information;
means for messaging the target population; and
means for iteratively expanding the target population based on message response information.

22. The system of claim 21, further comprising means for identifying the event.

23. A method comprising:
identifying a target population to respond to an event affecting an organization based on one or more descriptors of people relevant to the event, the one or more descriptors including at least one descriptor relating to personal scheduling information;
messaging the target population; and
iteratively expanding the target population based on message response information.

24. The method of claim 23, wherein iteratively expanding the target population is further based on a measure of criticality of the event to affect a time within which a resolution of the event is initiated.

25. An article comprising a machine-readable medium storing instructions operable to cause one or more machines to perform operations comprising:
receiving information corresponding to an event affecting an organization;
determining one or more descriptors of a population relevant to the event based on the received event information, the one or more descriptors including at least one descriptor relating to personal scheduling information;
identifying a subset of people in the organization relevant to the event based on the one or more descriptors;
sending one or more messages, including a request for response, to the identified subset of people;
expanding the subset of people based on message response information;
sending one or more additional messages, including a request for response, based on the expanded subset of people; and
initiating a resolution of the event based on the message response information.

26. The article of claim 25, wherein identifying the subset of people comprises identifying people that match the one or more descriptors to a first degree, and expanding the subset of people comprises identifying people that match the one or more descriptors to a second degree if the message response information comprises a lack of response.

27. The article of claim 25, wherein identifying the subset of people comprises performing data mining on email traffic and calendar entries.

28. The article of claim 25, wherein identifying the subset of people comprises comparing the one or more descriptors with personnel information pulled from multiple base systems.

29. The article of claim 28, wherein the multiple base systems comprise a human resource management system, a project management system, a time management system, and a communications management system.

30. The article of claim 25, wherein initiating the resolution of the event is further based on a measure of criticality of the event determined based on the received event information.

31. The article of claim 30, wherein initiating the resolution comprises:
generating a suggested resolution based on the message response information; and
sending the suggested resolution to a person associated with the received event information after a period governed by the measure of criticality.

32. The article of claim 31, wherein expanding the subset of people is performed after another period governed by the measure of criticality.

33. The article of claim 31, wherein generating the suggested resolution comprises generating the suggested resolution based on a lack of response.

34. The article of claim 31, wherein generating the suggested resolution comprises generating the suggested resolution based on a received response.

35. The article of claim 31, wherein initiating the resolution further comprises recalling unanswered messages after sending the suggested resolution.

36. The article of claim 25, wherein receiving the information corresponding to the event comprises receiving event-specific information generated using an event classification template.

37. The article of claim 36, wherein the at least one descriptor relating to personal scheduling information comprises an implicit descriptor requiring current availability, the implicit descriptor being implicit in an event class for the event.

38. The article of claim 36, wherein determining the one or more descriptors comprises retrieving the one or more descriptors from the received event-specific information.

39. The article of claim 36, wherein determining the one or more descriptors comprises deriving the one or more descriptors from the received event-specific information.

40. The article of claim 36, wherein sending the one or more messages comprises sending an email message including the request for response and event message information retrieved from the received event-specific information.
